(19) United States
(12) Patent Application Publication
(10) Pub. No.: US 2003/0134764 A1
(43) Pub. Date: Jul. 17, 2003

(54) Paint release compositions

(76) Inventor: Christopher H. Hensley, Grand Ledge, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/318,852

(22) Filed: Dec. 13, 2002

Related U.S. Application Data
(60) Provisional application No. 60/340,178, filed on Dec. 14, 2001.

(51) Int. Cl. C11D 7/18

(52) U.S. Cl. 510/201; 510/505; 510/506; 510/499; 510/375

(57) ABSTRACT

A paint release composition including an ether is disclosed. Activating agents may also be included in the paint release composition. Methods of making and using paint release compositions are also disclosed.

### CROSS-REFERENCE TO RELATED APPLICATION

This application claims priority to U.S. Provisional Application No. 60/340,178, filed on Dec. 14, 2001.

### FIELD OF THE INVENTION

This invention relates to compositions and methods of removing paint from various substrates.

### BACKGROUND OF THE INVENTION

Paint removing compositions commonly used in the industry include methylene chloride (MC), dimethyl sulfoxide (DMSO), N-methylpyrrolidone (NMP), ammonia, phenols, acids, or caustics. Each of these materials, however, has inherent problems. While MC containing compositions are the most common and cost-effective from a materials standpoint as a paint remover, MC is highly volatile, considered toxic and heavily regulated by OSHA and the EPA. MC is a known carcinogen and a classified as Hazardous Air Pollutant (HAP) by the EPA. Consequently, elaborate and expensive contaimnent, disposal, and exposure-limiting equipment and procedures are required which drive up the cost of using MC containing paint removers. Similarly, phenols are also highly toxic and known carcinogens. The efficacy of DMSO and NMP as paint removers is inadequate at ambient conditions and NMP is regulated by the EPA and must be reported appropriately when used in sufficient quantities.

Acid-based paint removers while effective, have a potential to cause a type of damage called hydrogen embrittlement to the high strength steel. In addition, over time, use of paint removers with a pH of less than about 6 cause metals, particularly aluminum alloys, cadmium plated steel, and magnesium, to become pitted or discolored from the corrosive effects of acids. These are major concerns for industries where these susceptible metals are favored. Consequently, paint removers with a pH less than 7.0 are generally not acceptable in these industries.

Caustic paint removers also require exposure-limiting equipment because they can cause burns and may have unpleasant odors. Caustic materials, such as ammonia, also attack aluminum over time, making them unsuitable for continued use.

Known removers also typically have a limited shelf life.

Thus, the inventor has recognized a need for an effective, economical paint remover that is non-toxic and suitable for use in wide range of applications.

### DETAILED DESCRIPTION

The present invention includes compositions or agents for removing various paints or protective coatings from a substrate. The compositions may be used to release any type of liquid, powder or electrostatic paint coatings; e.g., such as epoxies, acrylics, polyester lacquers, glycerophthalics, polyurethanes, polysulfide, and alkyd paints.

While primarily suitable for removing paint from metal substrates, the compositions may also be used on substrates such as cement, plastics, ceramics, fiberglass, glass and wood, whether porous or non-porous. The compositions are particularly useful where the painted substrate is susceptible to any form of corrosion.

The paint release compositions include at least an ether. The ether is selected from cyclic ethers containing at least one ring oxygen. Preferred ethers include those with at least two ring oxygens. Other substituents on the ring may also be present. The most preferred ether is dioxolane. Preferably, the selected ether is miscible in both polar and apolar solvents.

The composition may also include an activating agent. The activating agent may be selected from one of three categories: amines, inorganic peroxides, organic peroxides. Exemplary amines include alkanolamines such as monoethanolamine (MEA) and triethanolamine (TEA). Exemplary inorganic peroxides include hydrogen peroxide. While any grade of hydrogen peroxide may be used, high purity grades are preferred such as those provided by FMC Corp under the tradename Oxypure®. Exemplary organic peroxides include diacyl peroxides, ketone peroxides, peroxyesters, peroxydicarbonates, dialkyl peroxides, hydroperoxides and peroxyketals. Preferred ketone peroxides include methyl ethyl ketone peroxides (MEKP), such as those sold under the Luperox® DDM-9 tradename by Atofina Chemicals. Preferred dialkyl peroxides include dimethyl di-t-butylperoxyhexane, such as those sold under the Luperox® 101 tradename by Atonfina Chemicals.

The compositions may also include a variety of one or more co-solvents such as alcohols, water, aromatic solvents, esters, methylal, anisole, or pyrrols. The alcohol is preferably selected from aromatic alcohols, including one or more aromatic rings and one or more alcohol moieties such as fulrfuryl or benzyl alcohol or a combination thereof. Preferred alcohols include those with a single aromatic ring and a single alcohol moiety. The most preferred alcohol is benzyl alcohol. Substituents other than alcohol may also be present on the aromatic ring. The selected aromatic alcohol preferably has a high boiling point and a high flash point. The water is preferably de-ionized or distilled. One preferred type of aromatic solvents is naphthalene depleted solvents, such as those commonly known as Aromatic 150 ND and Aromatic 200 ND from Exxon Chemical.

The compositions may also include one or more additives. Rheological modifies, such as hydroxypropyl cellulose, hydroxymethyl cellulose, various gums, or combination thereof may be used to produce viscous compositions. Preferred rheological modifiers include the hydroxypropyl cellulose sold under the tradename Klucel H® by Hercules, Inc. Evaporation retardants, such as silicone oil, paraffin oil, or paraffin wax may also be included. Solubilizer-emulsifiers may be utilized such as sorbitan esters such as Tween85 or Span80, sodium xylene sulfonate and propylene glycol. An accelerator may be used, such as a humectant like glycerin or propylene glycol. Corrosion inhibitors may be used, such as benzotriaxoles, 2-mercaptobenzothiazole, toluoltriazole, boric acid derivatives, fatty acid alkanolamides and the like. Preferred corrosion inhibitors include those sold by Clairant AG under the Hostacor® tradename. Chelating agents such as phosphoric acid derivatives, EDTA and DTPA may also be used. A preferred chelating agent is Versonex 80 from Dow Chemical.

While not critical to the invention, the composition preferably has a pH in the range of about 6.5 to about 11. The pH may be adjusted through the addition of one or more of the activation agents or another agent such as a mild acid like glycolic, acetic, or malic acid.

In a first preferred embodiment, the ether is used without an activating agent. In a second preferred embodiment, the ether is used in combination with an amine activating agent. In a third preferred embodiment, the ether is used in combination with an inorganic peroxide activating agent. In a fourth preferred embodiment, the ether is used with an organic peroxide activating agent.

The first preferred embodiment of the present invention also includes an alcohol, water, a naphthalene depleted aromatic solvent, a Theological modifier, a solubilizer-emulsifier and a corrosion inhibitor.

In this first embodiment, the ether is present in the range of about 1-70 wt %, the alcohol is present in the range of about 1-60 wt %, the water is present in the range of about 1-75 wt %, the depleted naphthalene aromatic solvent is present in the range of about 1-20 wt %, the rheological modifier is present in the range of about 0-10 wt %, the solubilizer-emulsifier is present in the range of about 1-15 wt % and the corrosion inhibitor is present in the range of about 0. 1-10 wt %.

More preferred in this first embodiment is where the ether is present in the range of about 1-30 wt %, the alcohol is present in less than about 45 wt %, the water is present in less than about 60 wt %, the depleted naphthalene aromatic solvent is present in the range of about 5-15 wt %, the rheological modifier is present in the range of about 0-5 wt %, the solubilizer-emulsifier is present in the range of about 1-10 wt % and the corrosion inhibitor is present in the range of 0. 1-5 wt %.

The second preferred embodiment of the present invention also includes an alcohol, a water, a naphthalene depleted aromatic solvent, a rheological modifier, a solubilizer-emulsifier, corrosion inhibitor and an amine activating agent.

In this second embodiment, the ether is present in the range of about 1-70 wt %, the alcohol is present in the range of about 1-60 wt %, the water is present in the range of about 1-75 wt %, the depleted naphthalene aromatic solvent is present in the range of about 1-20 wt %, the rheological modifier is present in the range of about 0-10 wt %, the solubilizer-emulsifier is present in the range of about 1-15 wt %, the corrosion inhibitor is present in the range of about 0.1-10 wt % and the amine activating agent is present in the range of about 1-20 wt %.

More preferred in this second embodiment is where the ether is present in the range of about 1-30 wt %, the alcohol is present in less than about 45 wt %, the water is present in less than about 60 wt %, the depleted naphthalene aromatic solvent is present in the range of about 5-15 wt %, the rheological modifier is present in the range of about 0-5 wt %, the solubilizer-emulsifier is present in the range of about 1-10 wt %, the corrosion inhibitor is present in the range of about 0. 1-5 wt % and the amine activating agent is present in the range of about 1-10 wt %.

The third preferred embodiment of the present invention also includes an alcohol, a water, a naphthalene depleted aromatic solvent, a rheological modifier, a solubilizer-emulsifier, a corrosion inhibitor, a chelating agent and an inorganic peroxide activating agent.

In this third embodiment, the ether is present in the range of about 1-70 wt %, the alcohol is present in the range of about 1-60 wt %, the water is present in the range of about 1-75 wt %, the naphthalene depleted aromatic solvent is present in the range of about 1-20 wt %, the rheological modifier is present in the range of about 0-10 wt %, the solubilizer-emulsifier is present in the range of about 1-15 wt %, the corrosion inhibitor is present in the range of about 0.5-10 wt %, the chelating agent is present in the range about 1-10 wt % and the inorganic peroxide activating agent is present in the range of about 1-40 wt %.

More preferred in this third embodiment is where the ether is present in the range of about 1-30 wt %, the alcohol is present in less than about 45 wt %, the water is present in less than about 60 wt %, the naphthalene depleted aromatic solvent is present in the range of about 5-15 wt %, the rheological modifier is present in the range of about 0-5 wt %, the corrosion inhibitor is present in the range of about 0.5-5, the solubilizer-emulsifier is present in the range of about 1-10 wt %, the chelating agent is present in less than about 5 wt % and the inorganic peroxide activating agent is present in the range of about 1-30 wt%.

The fourth preferred embodiment of the present invention also includes an alcohol, a water, a naphthalene depleted aromatic solvent, a rheological modifier, a solubilizer-emulsifier, a corrosion inhibitor, a chelating agent, an accelerator and an organic peroxide activating agent.

In this fourth embodiment, the ether is present in the range of about 1-70 wt %, the alcohol is present in the range of about 1-60 wt %, the water is present in the range of about 1-75 wt %, the naphthalene depleted aromatic solvent is present in the range of about 1-20 wt %, the rheological modifier is present in the range of about 0-10 wt %, the solubilizer-emulsifier is present in the range of about 1-15 wt %, the corrosion inhibitor is present in the range of about 0.5-10 wt %, the chelating agent is present in the range about 1-10 wt %, the accelerator is present in the range about 1-10 wt % and the organic peroxide activating agent is present in the range of about 1-20 wt %.

More preferred in this fourth embodiment is where the ether is present in the range of about 1-30 wt %, the alcohol is present in less than about 45 wt %, the water is present in less than about 60 wt %, the naphthalene depleted aromatic solvent is present in the range of about 5-15 wt %, the rheological modifier is present in the range of about 0-5 wt %, the corrosion inhibitor is present in the range of about 0.5-5, the solubilizer-emulsifier is present in the range of about 1-10 wt %, the chelating agent is present in less than about 5 wt %, the accelerator is present in less than about 5 wt % and the organic peroxide activating agent is present in the range of about 1-10 wt%.

Table 1 includes detailed compositions of some of the most preferred embodiments of the present invention.

TABLE 1

| Formulation A | | | Formulation B | | |
|---|---|---|---|---|---|
| Benzyl Alcohol | 34 | wt % | Benzyl Alcohol | 34 | wt % |
| Aromatic 150 | 12 | wt % | Aromatic 150 | 15 | wt % |
| Polysorbitan ester | 3 | wt % | Polysorbitan ester | 3 | wt % |
| Dioxolane | 8 | wt % | Dioxolane | 10 | wt % |
| Hydroxy | 0.7 | wt % | Hydroxy | 0.75 | wt % |
| propylcellulose | | | propylcellulose | | |
| Hostacor 2098 | 0.8 | wt % | Malic acid | 1 | wt % |
| MEA | 2.5 | wt % | Hydrogen peroxide | 8.8 | wt % |
| Deionized water | Balance | | Versonex 80 | 2.2 | wt % |
| | | | Deionized water | Balance | |
| Formulation C | | | Formulation D | | |
| Benzyl Alcohol | 35 | wt % | Benzyl Alcohol | 35 | wt % |
| Aromatic 150 | 12 | wt % | Aromatic 150 | 12 | wt % |
| Polysorbitan ester | 3 | wt % | Polysorbitan ester | 3 | wt % |
| Dioxolane | 6 | wt % | Dioxolane | 6 | wt % |
| Hydroxy | 0.7 | wt % | Hydroxy | 0.7 | wt % |
| propylcellulose | | | propylcellulose | | |
| Paraffin | 0.3 | wt % | Paraffin | 0.3 | wt % |
| Glycerin | 3 | wt % | Glycerin | 3 | wt % |
| TEA | 3 | wt % | MEKP | 3 | wt % |
| Glycolic acid | 10 | wt % | Glycolic acid | 10 | wt % |
| Versonex 80 | 1.3 | wt % | Versonex 80 | 1.3 | wt % |
| Deionized water | Balance | | Deionized water | Balance | |
| Formulation E | | | Formulation F | | |
| Benzyl Alcohol | 35 | wt % | Beuzyl Alcohol | 35 | wt % |
| Aromatic 150 | 12 | wt % | Aromatic 150 | 12 | wt % |
| Polysorbitan ester | 3 | wt % | Polysorbitan ester | 3 | wt % |
| Dioxolane | 6 | wt % | Dioxolane | 6 | wt % |
| Hydroxy | 0.7 | wt % | Hydroxy | 0.8 | wt % |
| propylcellulose | | | propylcellulose | | |
| Paraffin | 0.3 | wt % | Paraffin | 0.3 | wt % |
| Glycerin | 3 | wt % | Glycerin | 3 | wt % |
| MEKP | 3 | wt % | MEKP | 4 | wt % |
| Versonex 80 | 1.3 | wt % | Versonex 80 | 1.5 | wt % |

| | | | |
|---|---|---|---|
| Deionized water | Balance | Deionized water | Balance |

The compositions may be formed as a water-in-oil emulsion which is stable for 6 months to a year at ambient environmental conditions. One useful method of making a water-in-oil emulsion is described below. A first phase is made of the ether, the evaporation retardant, the alcohol, the naphthalene depleted aromatic solvent, the corrosion inhibitor and the rheological modifier. A second phase is made of the water, the solubilizer-emulsifier, the chelating agent and the activating agent. Other additives may be included in either phase. The second phase is slowly dispersed in the first phase as the mixture is stirred. After the second phase is fully added, the mixing speed is increased so that the rheological modifier in the mixture is overcome; i.e., the viscosity of the mixture increases and forms a homogeneous mixture. Upon this occurring, the mixing speed is reduced to a constant speed.

In one particularly useful method, the first phase is made by sequentially adding the ether, the evaporation retardant, the alcohol, the naphthalene depleted aromatic solvent, the corrosion inhibitor and the Theological agent. The first phase is preferably blended for 45 minutes at 350-500 rpm. The second phase is made by sequentially adding the water, the solubilizer-emulsifier, the chelating agent and then the activating agent. The second phase is also preferably blended for 45 minutes at 350-500 rpm. After the dispersion of the second phase in the first phase is completed, the blending speed is then increased to 1500-1700 rpm to create high shearing blending. The high shearing blending is preferably carried out until the second phase folds into the first phase to form an emulsion. This is indicated by a sudden increase in viscosity and swelling of the composition into a single phase; normally 5-15 minutes is adequate. After this point, the mixture will be blended at 1200 rpm for one hour. The material is left to sit overnight to allow for the total uptake and dissolving of the rheological modifier. The composition is then reblended at 350-500 rpm for a period of 45 minutes-1 hour. The composition resultant from this blending process is a viscous material capable of clinging to vertical and overhead surfaces for period of time sufficient to remove paint.

The present invention also relates to methods of removing paints and coatings, as well as to methods of applying the above described compositions. As with other paint removers, the compositions are applied to substrates in need of stripping. The composition releases the paint from the substrate by attacking any bonding that may attach the paint to the substrate. Because of the general absence of OSHA and EPA regulated compounds and the inherent safety of the composition, minimal safety equipment is required by the person applying the compositions. Similarly, these compositions can be used in an unlimited fashion in enclosed spaces. These compositions can be removed from the substrate, along with the paint or coating, through a water spray. Pressure enhancing equipment may or may not be used. The water spray need not scour the substrate to remove the paint. Rather, the water may be used to wash off paint which is residually, yet tenuously, attached to the substrate. Clean-up of these compositions consists almost exclusively of filtering the paint residue from the resultant post-removal waste. This is because the composition does not dissolve the paint being removed, but releases the paint's hold on the substrate.

The compositions of the present invention may be applied through conventional methods such as wiping the composition onto the surface to be stripped. The surface to be stripped may also be dipped in the compositions. Preferably, the compositions are sprayed on to the surface to be stripped. Such spray application of the compositions may be accomplished by including a propellant to form an aerosolizeble composition. Conventional propellants such as dimethyl ether, hydrocarbons or compressed air may be utilized. While apparatus capable of spraying large surface areas are preferred, hand held apparatuses for spraying small, discrete areas are also contemplated.

When applying the composition as an aerosol spray where the propellant is not compressed air, the composition preferably has the components shown in Table 2.

TABLE 2
Formulation G

| | | |
|---|---|---|
| Benzyl Alcohol | 34 | wt % |
| Aromatic 150 | 12 | wt % |
| Polysorbitan ester | 3 | wt % |
| Dioxolane | 10 | wt % |
| Hydroxy propylcellulose | 0.4 | wt % |
| Paraffin wax | 0.25 | wt % |
| MEA | 2.5 | wt % |

| | |
|---|---|
| Deionized water | Balance |

The components for the aerosol composition are mixed as follows. The first phase is made by sequentially adding the alcohol, the evaporation retardant and rheological modifier. The first phase is blended for 45 minutes to 1 hour at 1200 to 1400 rpm. The second phase is made by sequentially adding the ether, the water, the naphthalene depleted aromatic solvent, the solubilizer-emulsifier and the activating agent. The second phase is blended for 30 minutes at 850-1200 rpm. The blending speed is decreased to 500 rpm while the second phase is slowly dispersed into the first phase. After complete dispersion of the second phase into the first phase is completed, the blending speed is increased to 1200-1400 rpm to create high shearing blending of the two phases, where upon the composition will emulsify into a semi-thick homogeneous solution. The composition is then left to sit overnight to allow for total uptake and dissolving of the rheological modifier. The composition is then reblended at 500-850 rpm for a period of 45 minutes to 1 hour. The resultant composition is then packaged in an aerosol can at a ratio of 70 wt % product to 30 wt % dimethylether propellant. This will result in sprayable foaming product capable of clinging to vertical and overhead horizontal surfaces. Paint removal is normally accomplished in under 2 hours although longer periods may be required for certain types of paints.

### WORKING EXAMPLES

The Formulations 1-4 were made according to the two-phase method discussed above, while Formulation 5 was made according to the aerosol method discussed above. The make up of the Formulations is shown in Table 3.

TABLE 3

| Formulation 1 | | | Formulation 2 | | |
|---|---|---|---|---|---|
| Benzyl Alcohol | 34 | wt % | Benzyl Alcohol | 34 | wt % |
| Aromatic 150 | 12 | wt % | Aromatic 150 | 12 | wt % |
| Dioxolane | 6 | wt % | Dioxolane | 18 | wt % |
| Tween 85 | 3 | wt % | Tween85 | 3 | wt % |
| Hostacor 2098 | 0.8 | wt % | Hostacor 2098 | 0.8 | wt % |
| MBA | 2.5 | wt % | Oxypure (35%) | 8.8 | wt % |
| Hydroxypropyl | 0.7 | wt % | Hydroxypropyl | 0.7 | wt % |
| Cellulose | | | Cellulose | | |
| DI Water | Balance | | Versonex 80 | 1.3 | wt % |
| | | | DI Water | Balance | |
| Formulation 3 | | | Formulation 4 | | |
| Benzyl Alcohol | 34 | wt % | Benzyl Alcohol | 34 | wt % |
| Aromatic 150 | 12 | wt % | Aromatic 150 | 12 | wt % |
| Dioxolane | 8 | wt % | Dioxolane | 8 | wt % |
| Tween 85 | 3 | wt % | Tween 85 | 3 | wt % |
| Hostacor 2098 | 0.8 | wt % | Hostacor 2098 | 0.8 | wt % |
| Oxypure (35%) | 8.8 | wt % | Luperox 101 | 3.0 | wt % |
| Hydroxypropyl | 0.7 | wt % | Hydroxypropyl | 0.7 | wt % |
| Cellulose | | | Cellulose | | |
| Malic Acid | 0.3 | wt % | Versonex 80 | 1.3 | wt % |

| | | | | |
|---|---|---|---|---|
| Versonex 80 | 1.3 | wt % | DI Water | Balance |

| | |
|---|---|
| DI Water | Balance |

| Formulation 5 (Aerosol) | | |
|---|---|---|
| Benzyl Alcohol | 34 | wt % |
| Aromatic 150 | 12 | wt % |
| Dioxolane | 8 | wt % |
| Tween 85 | 3 | wt % |
| Hostacor 2098 | 0.8 | wt % |
| MBA | 3.0 | wt % |
| Hydroxypropyl | 0.3 | wt % |
| Cellulose | | |
| Paraffin Wax | 0.2 | wt % |
| Versonex 80 | 1.3 | wt % |

| | |
|---|---|
| DI Water | Balance |

Comparison Formulations were purchased. Napier PMA is a blend of benzyl alcohol, glycolic acid, hydrogen peroxide, and water. Eldorado 3170/5000 is a kit system comprised of Part A and B. Part A is made up of benzyl alcohol and about 10 wt % hydrogen peroxide. Part B is comprised of ammonium hydroxide (Aqua Ammonia). The two parts are very unstable together and must be mixed by using a dual pump system that combines the two parts at the spray nozzle tip just before application to the surface being stripped. Eldorado 5044 is a hydrogen peroxide/benzyl alcohol formula. This product is exothermic and can be very dangerous if not handled properly.

Each Formulation and Comparison Formulation was applied to seven painted substrates and the speed at which the paint was removed was observed. Formulations 1-4 were spotted on a horizontal painted substrate, while Formulation 5 was sprayed from a 14 oz tin plated aerosol can filled with 70% Formulation 5, by weight, and 30% dimethylether by weight. Comparison Formulations were also spotted on a horizontal painted substrate.

Table 4 illustrates the layers of paint and coating included in each tested system. The corresponding military or industrial standard for the paint, coating or substrate is listed parathetically.

TABLE 4

| | |
|---|---|
| System A | |
| Topcoat | Polyurethane (MIL-C-85285) |
| Primer Coat | Flexible primer (MIL-P-2760 Type 1) |
| Substrate | Aluminum (AMS 4041) |
| System B | |
| Topcoat | Polyurethane (MIL-C-85285) |
| Primer Coat | Epoxy (MIL-PRF-23377 Type 1, Class C) |
| Substrate | Aluminum (AMS 4041) |
| System C | |
| Topcoat | Polyurethane (MIL-PRF-85285) |
| Intermediate | Epoxy (MIL-PRF-23377 Type 1, Class C) |
| Coat | |
| Primer Coat | Polysulfide (MIL-PRF-81733 Type 3 Sealant) |
| Substrate | Aluminum (AMS 4041) |
| System D | |
| Topcoat | Polyurethane (MIL-PRF-85285) |
| Primer Coat | Koroflex Flexible coating (TT-P-2760 Type 1, Class C) |
| Substrate | Aluminum (AMS 4041) |
| System E | |
| Topcoat | Boeing BMS 10-60 TyII |
| Primer Coat | Boeing BMS 10-79 TyII |
| Substrate | Aluminum (AMS 4041) |
| System F | |
| Topcoat | Boeing BMS 10-100 |
| Primer Coat | Boeing BMS 10-79 Type 3 |
| Substrate | Aluminum (AMS 4041) |
| System G | |
| Topcoat | Epoxy (MIL-R-8 1294) |
| Substrate | Aluminum (AMS 4041) |

Table 5 illustrates the time each Formulation and Comparative Formulation required to remove the paint and coatings from each system.

TABLE 5

| | System A | System B | System C | System D | System E | System F | System G |
|---|---|---|---|---|---|---|---|
| Formulation 1 | 80 min | 116 min | 410 min* | 120 min | 40 min | No Effect | 98 min |
| Formulation 2 | 22 min | 18 min | 146 min | 54 min | 39 min | 78 min | 16 min |
| Formulation 3 | 28 min | 37 min | 185 min | 75 min | 23 min | 120 min | 21 min |
| Formulation 4 | 158 min | 152 min | 240 min | 78 min | 35 min | 123 min | 24 min |
| Formulation 5 | 68 min | 94 min | 340 min* | 110 min | 35 min | 112 min | 25 min |
| Napier PMA | 31 min | 34 min | 188 min | 62 min | 24 min | 123 min | 16 min |
| Eldorado PR- | 29 min | 34 min | No Effect | 132 min | 45 min | No Effect | 62 min |
| 3170/5000 | | | | | | | |
| Eldorado PR- | 105 min | 75 min | 210 min | 82 min | 40 min | 127 min | 16 min |
| 5044 | | | | | | | |

*Top and intermediate coatings were removed but no effect on the polysulfide primer was observed.

As can be seen from Table 5, the inventive Formulations were superior to the Comparative Formulations in side by side testing. Formulation 2 removed the paint and coatings the fastest in Systems A-D and F and tied for the fastest in System G. In System E, Formulation 3 was the quickest. Formulations 1-5 worked quickly against a broad spectrum of paint types and are relatively benign to the environment and the people using the Formulations.

While the invention has been specifically described in connection with certain specific embodiments thereof, it is to be understood that this is by way of illustration and not of limitation, and the scope of the appended claims should be construed as broadly as the prior art will permit.

I claim:

1. A composition comprising a paint release agent including a cyclic ether.

2. The composition of claim 1, wherein the cyclic ether is dioxolane.

3. The composition of claim 1, wherein the paint release agent further includes an activating agent selected from the group consisting of amines, inorganic peroxides, organic peroxides and combinations thereof.

4. The composition of claim 3, wherein the amine activating agent is an alkanolamine.

5. The composition of claim 4, wherein the alkanolamine is monoethanolamine or triethanolamine.

6. The composition of claim 3, wherein the inorganic peroxide activating agent is hydrogen peroxide.

7. The composition of claim 3, wherein the organic peroxide activating agent is selected from a group consisting of diacyl peroxides, peroxyesters, peroxydicarbonates, dialkyl peroxides, keytone peroxides, peroxyketals, hydroperoxides, and combinations thereof.

8. The composition of claim 7, wherein the ketone peroxide is methyl ethyl ketone peroxide.

9. The composition of claim 7, wherein the dialkyl peroxide is dimethyl di-t-butylperoxyhexane.

10. The composition of claim 3, wherein the paint release agent further includes at least one co-solvent selected from the group consisting of alcohols, water, and aromatic solvents.

11. The composition of claim 10, wherein the alcohol is benzyl alcohol.

12. The composition of claim 10, wherein the aromatic solvent is a naphthalene depleted aromatic solvent.

13. The composition of claim 3, wherein the paint release agent further includes at least one of a Theological modifier, an evaporation retardant, a solubilizer-emulsifier, a corrosion inhibitor or a chelating agent.

14. A method removing paint from a substrate, comprising:
applying a composition including a cyclic ether to substrate in need of paint removal.

15. The method claim 14, wherein the cyclic ether is dioxolane.

16. The method of claim 14, wherein the applied composition further includes an activating agent selected from the group consisting of amines, inorganic peroxides, organic peroxides and combinations thereof.

17. The method of claim 14, wherein the applied composition further includes at least one co-solvent selected from the group consisting of alcohols, water, and aromatic solvents.

18. The method of claim 14, wherein the applied composition further includes at least one of a Theological modifier, a solubilizer-emulsifier, an evaporation retardant, a corrosion inhibitor or a chelating agent.

19. The method of claim 14 wherein the applying step includes spraying the composition using a propellant selected from dimethyl ether, a hydrocarbon, or compressed air.

20. A method of using a cyclic ether, comprising:
releasing paint from a substrate with a composition including a cyclic ether.

21. The method of claim 20, wherein the cyclic ether is dioxolane.

22. The method of claim 20, wherein the composition further includes an activating agent selected from the group consisting of amines, inorganic peroxides, organic peroxides and combinations thereof.

23. The method of claim 20, wherein the composition further includes at least one co-solvent selected from the group consisting of alcohols, water, and aromatic solvents.

24. The method of claim 20, wherein the composition further includes at least one of a rheological modifier, a solubilizer-emulsifier, an evaporation retardant, a corrosion inhibitor or a chelating agent.

25. A method of making a paint release agent, comprising:
forming a first phase of an alcohol, an-evaporation retardant and a Theological modifier;
forming a second phase of a water, a cyclic ether, an aromatic solvent, a solubilizer-emulsifier, and an activating agent; and
dispersing the second phase in the first phase by blending the two phases together.
